(19) United States
(12) Patent Application Publication
(10) Pub. No.: US 2025/0371542 A1
(43) Pub. Date: Dec. 4, 2025

(54) METHOD OF AUTHORIZING FINANCIAL TRANSACTIONS USING A PHONE NUMBER AND A BIOMETRIC TRAIT

(71) Applicant: MASTERCARD INTERNATIONAL INCORPORATED, Purchase, NY (US)

(72) Inventor: Ajinkya Nivrutti Ranaware, Mumbai (IN)

(21) Appl. No.: 18/676,364

(22) Filed: May 28, 2024

(51) Int. Cl. G06Q 20/40; G06Q 20/20

(52) U.S. Cl. CPC G06Q 20/40145; G06Q 20/20; G06Q 20/4012

(57) ABSTRACT

A method of authorizing financial transactions is provided. The method may be easier for consumers to make purchases because the consumer only needs to remember their phone number and present a biometric trait of the consumer like a fingerprint. In order to initiate a financial transaction, the user enters their phone number. In response, a list of financial accounts that are linked to the phone number are listed. The consumer then selects one of the accounts to pay for a purchase. The consumer also inputs a biometric trait which is compared with a corresponding stored copy of the biometric trait to determine if there is a match before completing the transaction.

### BACKGROUND

The present inventions relate generally to financial transaction processing, and more particularly, to methods of authorizing financial transactions to protect consumers from account fraud.

Modern consumer payment systems usually involve one or more banks as well as various support services. In such systems, the consumer will typically have an account with a bank that offers cash account or credit account services. When making a purchase from a merchant, the consumer provides the merchant with information about an account that the consumer has with a bank, such as a credit or debit card number. The merchant then submits the purchase amount and account information to the consumer's bank and receives payment from the bank if the bank approves the transaction.

Because modern consumer payment systems are designed to process thousands of payment requests in short periods of time, such systems tend to attract criminals who seek to deceive the system into paying for purchases from a consumer's bank account that have not been authorized by the consumer. One security measure that can reduce the likelihood of fraudulent transactions is to require the consumer to present a physical card like a credit or debit card to the merchant in order to process a transaction. However, this is a relatively weak method of authorizing financial transactions because it is relatively common for consumers to lose physical cards through forgetfulness or theft. Thus, it is not uncommon for a criminal to come into possession and fraudulently use financial cards owned by innocent consumers.

There are a number of problems with physical financial cards. For example, it is easier for criminals to steal the card number and CVV number from a physical financial card. Another problem with physical financial cards is their inconvenience. That is, in order to make a purchase at a merchant's storefront, the consumer must carry a physical financial card with them. As noted, the consumer must also remain vigilant to not lose the card. Therefore, it would be desirable for authorization methods for financial transactions to be more secure to prevent criminals from making unauthorized financial transactions. It would also be desirable for consumers to be able to conduct financial transactions easier without having to carry extra physical items with them like a credit or debit card.

### SUMMARY

A method of authorizing financial transactions is described that allows consumers to make a payment for a purchase without needing to present a physical credit or debit card to the merchant. In order to initiate a purchase, a consumer enters their phone number into a point-of-sale device or other computer device. A PIN or password may also be required to proceed with the purchase. A list of financial accounts that are linked to the phone number are then listed for the consumer to select one of the accounts for completing the transaction. The consumer also inputs a biometric trait of the consumer like a fingerprint. The entered biometric trait is then compared with a corresponding stored copy of the biometric trait to determine if there is a match. If the entered biometric trait matches the corresponding stored copy of the biometric trait, the financial transaction is approved, and the financial transaction is rejected if there is no match. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawings, in which:

FIG. 1 is a block diagram of an example multi-party payment card network system, including a first and second data center and an off-line scheduler, in accordance with one embodiment of the disclosure;

FIG. 2 illustrates a point of sale device for use by a consumer;

FIG. 3A illustrates a first display of the point of sale device;

FIG. 3B illustrates a second display of the point of sale device;

FIG. 3C illustrates a third display of the point of sale device;

FIG. 3D illustrates a fourth display of the point of sale device;

FIG. 3E illustrates a fifth display of the point of sale device; and

FIG. 4 illustrates a schematic of a method for authorizing financial transactions.

### DETAILED DESCRIPTION

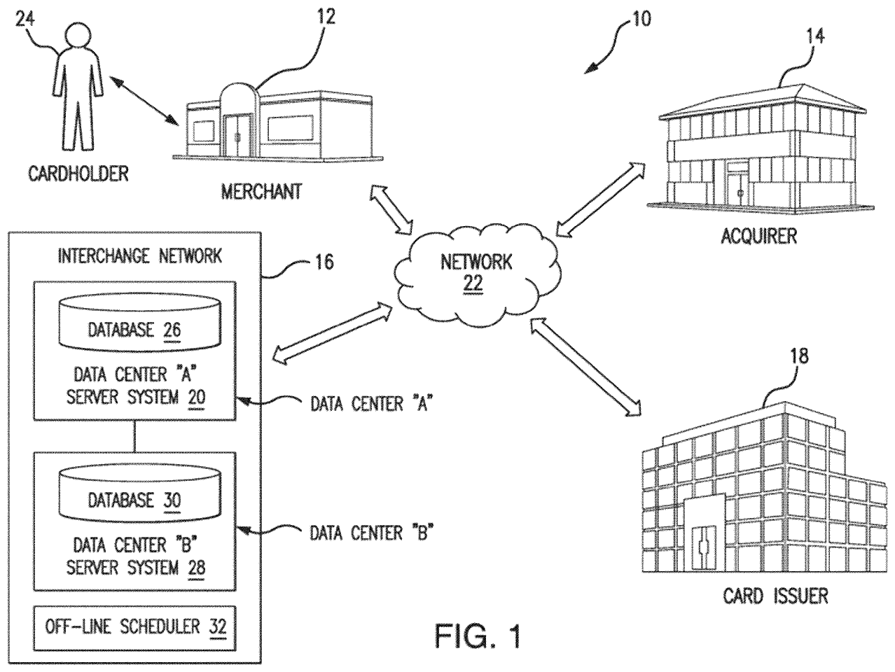

FIG. 1 is a block diagram of an example multi-party payment card network system 10, including a data center A, a data center B, and an off-line scheduler 32. The payment card network system 10 facilitates providing interchange network services offered by an interchange network 16. In addition, the payment card network system 10 enables payment card transactions in which merchants 12, acquirers 14, and/or card issuers 18 do not need to have a one-to-one relationship. Although parts of the payment card network system 10 are presented in one arrangement, other embodiments may include the same or different parts arranged otherwise, depending, for example, on authorization processes for purchase transactions, communication between computing devices, etc.

In the example embodiment, the payment card network system 10 generally includes the merchants 12, the acquirers 14, the interchange network 16, and the issuers 18 coupled in communication via a network 22. The network 22 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 22 may include more than one type of network, such as a private payment transaction network provided by the interchange network 16 to the acquirers 14 and/or the issuers 18, and separately, the public Internet, which may facilitate communication between the merchants 12, the interchange network 16, the acquirers 14, and/or cardholders 24.

Embodiments described herein may relate to a transaction card system, such as a credit card payment system using the Mastercard® interchange network. (Mastercard is a registered trademark of Mastercard International Incorporated). The Mastercard interchange network is a set of proprietary communications standards promulgated by Mastercard for the exchange of financial transaction data and the settlement of funds between financial institutions that are members of Mastercard. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 10.

In a typical transaction card system, a financial institution called the “issuer” issues a transaction card, such as a credit card, to a cardholder or consumer 24, who uses the transaction card to tender payment for a purchase from the merchant 12. In the example embodiment, the merchant 12 is typically associated with products, for example, and without limitation, goods and/or services, that are offered for sale and are sold to the cardholders 24. The merchant 12 includes, for example, a physical location and/or a virtual location. A physical location includes, for example, a brick-and-mortar store, etc., and a virtual location includes, for example, an Internet-based store-front.

To accept payment with the transaction card, the merchant 12 must normally establish an account with a financial institution that is part of the payment card network system 10. This financial institution is usually called the “merchant bank,” the “acquiring bank,” or the acquirer 14. When the cardholder 24 provides payment for a purchase with a transaction card, the merchant 12 requests authorization from the acquirer 14 for the purchase amount. The request may be performed over the telephone but is usually performed using a point-of-sale terminal that reads the cardholder's account information from a magnetic stripe, a chip, or embossed characters on the transaction card and communicates electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase transaction is covered by the cardholder's available credit line. Based on these determinations, the request for authorization will be declined or accepted. If the request is accepted, an authorization code is issued to the merchant 12. Each of these transactions may be stored by the interchange network 16 in one or more tables (not shown) that make up one or more computer databases, such as databases 26 and 30. It is noted that the databases 26 and 30, described herein, may be database servers and may be discrete servers distributed remotely from one another.

When a request for authorization is accepted, the available credit line of the cardholder's account is decreased. Normally, a charge for a payment card transaction is not posted immediately to the cardholder's account because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder 24 cancels a transaction before it is captured, a “void” is generated. If the cardholder 24 returns goods after the transaction has been captured, a “credit” is generated. The interchange network 16 and/or the issuer 18 stores the transaction data, such as, and without limitation, payment account number (PAN), a type of merchant, a merchant identifier, a location where the transaction was completed, an amount of purchase, a merchant category code, a date and time of the transaction, products purchased and related descriptions or identifiers, etc., in a transaction database, such as the databases 26 and 30.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12. It should be appreciated that more or less information related to transactions, as part of either authorization, clearing, and/or settling, may be included in the transaction data, and stored within the databases 26 and 30, at the merchant 12, the acquirer 14, the payment network 16, and/or the issuer 18. Further, transaction data, unrelated to a particular payment account, may be collected by a variety of techniques, and similarly stored within the databases 26 and 30.

In some embodiments, cardholders 24 involved in the transactions described herein are prompted to agree to legal terms associated with their payment accounts, for example, during enrollment in such payment accounts, etc. As such, the cardholder 24 may voluntarily agree to allow the merchants 12, the issuers 18, the interchange network 16, etc., to utilize data collected during enrollment and/or collected relating to processing the transactions, subsequently for one or more of the purposes described herein.

In the exemplary embodiment, the interchange network 16 includes a plurality of data centers, such as the data center A and the data center B (e.g., data centers for redundancy, data centers in distant geographical locations for network efficiency, etc.). Each data center includes a respective data center server system, such as data center A server system 20 and data center B server system 28. The server systems 20 and 28 include a plurality of applications that can be accessed by any of the merchants 12, the acquirers 14, the issuers 18, and/or the cardholders 24. The applications typically are accessed via one or more application programming interfaces (APIs).

APIs, as used herein, are how various separate services work together to deliver a solution. For example, and without limitation, in online banking, when the cardholder 24 logs in, usually the first thing the cardholder sees is his or her account balance. To deliver that solution, fundamentally two separate banking functions (or applications) work together (e.g., a login service and account balance service) to allow the cardholder 24 to see how much money he or she has in the account. How those two (2) services manage to work together is through an API. Example Mastercard APIs include, for example, Automatic Billing Updater (ABU), BIN Table Resource, MDES, Merchant Identifier, Cardless ATM, Mastercard Send, Masterpass, etc.

Referring back to FIG. 1, in the exemplary embodiment, the server systems 20 and 28 are configured to allow data, such as the transaction data, to be stored by a group of computers, and updated by one or more members of the group. While the interchange network 16 is illustrated as a single component in FIG. 1, it should be appreciated that the interchange network 16 may be a network of distributed computers or data centers, each coupled to the payment card network system 10, for example, via the network 22. For example, and without limitation, each of data centers A and B may be geographically remote from each other data center, or they may be housed in a single data center but be physically separate databases.

The off-line scheduler 32 is configured to determine a change window (e.g., a time period) for taking one or more of the plurality of applications associated with the server systems 20 and 28 off-line. In particular, the off-line scheduler 32 analyzes the applications to determine which of the one or more APIs map to the application. For each of the applications, the off-line scheduler 32 performs a failure analysis on the APIs that map to the application to determine whether any of the APIs are single point of failure (SPOF) APIs. Based on the API failure analysis, the off-line scheduler 32 assigns a priority level to the application. The off-line scheduler 32 analyzes the historical data corresponding to the volume of network traffic for the APIs. Based on the application priority level and the historical network traffic data, the off-line scheduler 32 determines a change window for taking each respective application off-line that will reduce a negative impact on the operations of, for example, the merchant 12, acquirer 14, issuer 18, cardholder 24, etc.

While only one merchant 12, acquirer 14, interchange network 16, and issuer 18 are shown in FIG. 1 (for ease of reference), it should be appreciated that a variety of other embodiments may include multiple ones of these parties in various combinations.

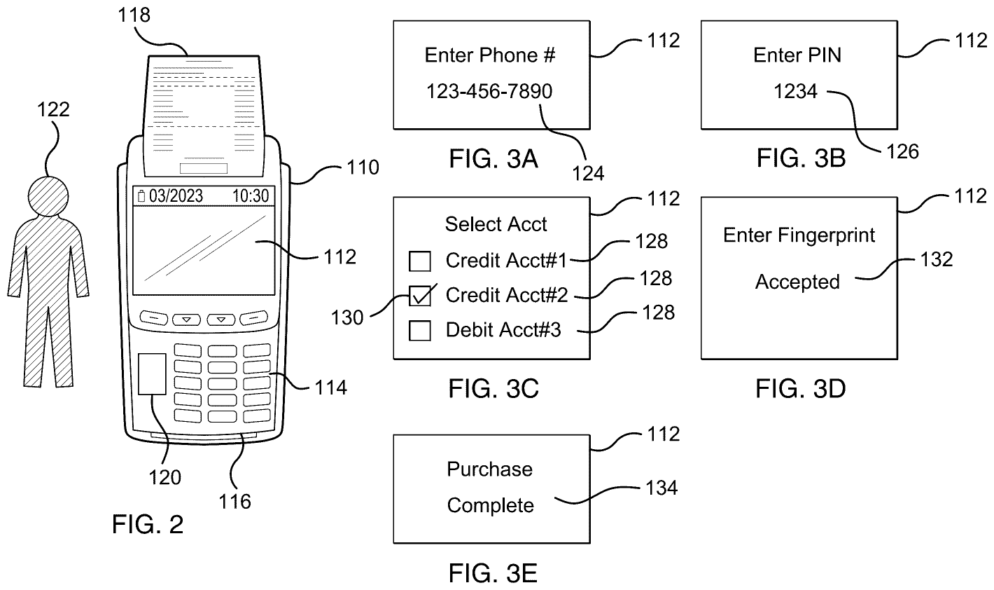

Referring now to FIG. 2, a point-of-sale (POS) device 110 is shown. As shown, typical POS devices 110 have a display screen 112, a number pad 114, a financial card reader 116 and a receipt printer 118. In the present embodiment of the invention, the POS device 110 also has a biometric reader 120, such as a fingerprint scanner 120. The POS device 110 is preferably physically located at a merchant's site, such as a physical storefront, where a consumer 122 can directly interact with the POS device 110 to authorize a financial transaction in order to complete a purchase of a good or service. Alternatively, the consumer 122 may also implement the method herein remotely from a merchant's site using a computer device like a mobile phone with a display screen, number pad and a biometric reader like a fingerprint scanner.

Turning to FIG. 3A, a consumer 122 may initiate the payment process for a purchase by entering the numbers of the consumer's phone number 124 into the POS device 110 using the number pad 114. As shown in FIG. 3B, the system may then require the consumer 122 to enter a PIN or password 126. The PIN or password 126 is preferably known only to the consumer 122 to increase the level of security of the system. As shown in FIG. 3C, the POS device 110 then displays a plurality of financial accounts 128 belonging to the consumer 122 on the display 112. As described further below, the financial accounts 128 of the consumer 122 have been linked to the consumer's phone number 124 so that whenever the consumer 122 enters their phone number 124 into a POS device 110 or when making a remote purchase like on a website the system will display the linked financial accounts 128. Although the system may be used by only entering the consumer's phone number 124, it may be desired to also require the PIN or password 126 for increased security. As a result, the consumer's financial accounts 128 may only be displayed if the entered PIN or password 126 matches a corresponding stored copy of the PIN or password 126. Thus, the consumer 122 is able to utilize their financial accounts 128, such as credit card accounts and debit card accounts 128, without needing to have a physical financial card with them and without having to remember any specific information about their financial accounts 128 besides their own phone number 124 and their PIN or password 126 if used.

Once the consumer 122 selects 130 one of the listed financial accounts 128 for the financial transaction, the system requires the consumer 122 to input a biometric trait 132 of the consumer 122 like a fingerprint 132 using the biometric reader 120 as shown in FIG. 3D. The system then compares the entered biometric trait 132 with a corresponding stored copy of the consumer's biometric trait 132 to determine if the entered biometric trait 132 matches the stored copy of the biometric trait 132. For example, where the biometric trait 132 is a fingerprint 132, the consumer 122 may have previously provided a copy of their fingerprint 132 to an organization that the system is able to access so that the system can compare the fingerprint 132 entered into the POS device 110 with the previously provided and stored copy of the consumer's fingerprint 132. As shown in FIG. 3E, if the entered biometric trait 132 matches the corresponding stored copy of the biometric trait 132, the system then authorizes the financial transaction to complete the purchase 134. On the other hand, if the entered biometric trait 132 does not match the corresponding stored copy of the biometric trait 132, this may mean that there is a high likelihood that the individual 122 trying to make the purchase is a criminal engaged in fraud. Thus, the system will reject the financial transaction with the selected financial account 130 if the entered biometric trait 132 does not match the corresponding stored copy of the biometric trait 132. Accordingly, the system is able to authorize financial transactions for consumers 122 using only the consumer's phone number 124 and biometric trait 132 like a fingerprint 132 and a PIN or password 126 if used. This makes it considerably easier for consumers 122 to complete purchases since the consumer 122 does not need to present a physical or digital financial card to the merchant 110 while also maintaining high security when authorizing transactions.

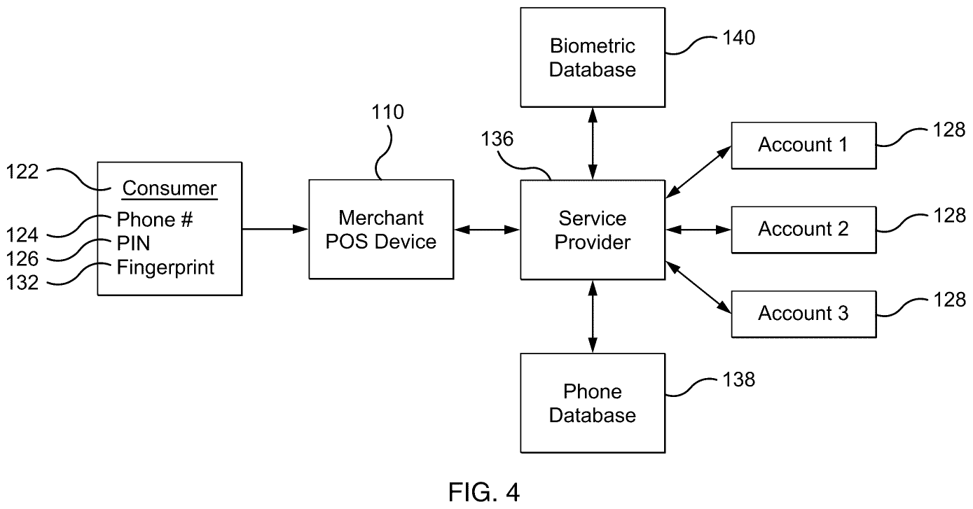

Turning to FIG. 4, the consumer 122 initiates a financial transaction by entering the consumer's phone number 124, PIN or password 126 and a biometric trait 132 like a fingerprint 132 into a POS device 110 or remotely on a computer device (e.g., a website on the consumer's mobile phone). The merchant 110 receives this information from the consumer 122 through the POS device 110, a website or other means. In most embodiments, the merchant 110 will then transmit the information to a financial service provider 136. Typically, the information received from the consumer 122 is transmitted to the service provider 136 in steps instead of all at once. That is, the consumer's phone number 124 (with or without the PIN or password 126) is transmitted first to the service provider 136. The service provider 136 then accesses a phone database 138 which links many consumer's phone numbers 124 with the financial accounts 128 that are associated with each consumer 122. In some embodiments, it may be desirable for the phone database 138 to be maintained by a financial services organization that is different from the financial institutions that are associated with the financial accounts 128 of consumers 122 since this allows all of the consumer's financial accounts to be listed regardless of the financial institutions associated with each account. Once the service provider 136 determines which financial accounts 128 belong to the consumer 122 based on the consumer's phone number 124, the service provider 136 transmits information about the accounts 128 back to the merchant 110. If a PIN or password 126 is used, the PIN or password 126 may be stored in the phone database 138 with a link to the consumer's phone number 124 so that the service provider 136 can determine if the entered PIN or password 126 matches the PIN or password 126 associated with the consumer's phone number 124.

The merchant 110 then displays multiple financial accounts 128 belonging to the consumer 122 on the POS device 110 or other user interface. As described above, the consumer 122 then selects one of the financial accounts 130 for conducting the financial transaction. The consumer 122 then also inputs their biometric trait 132 into the POS device 110. In response, the merchant 110 transmits the biometric trait 132 to the service provider 136.

In order to verify that the individual 122 who entered the biometric trait 132 is the actual consumer 122 associated with the selected financial account 130, the service provider 136 then accesses a biometric database 140. The biometric database 140 contains stored copies of one or more biometric traits 132 for many different consumers 122. Thus, where the biometric trait 132 is a fingerprint 132, the biometric database 140 will be a fingerprint database 140 for many different consumers 122. The stored copies of the biometric trait 132 may be linked to the consumer's accounts 128 in various ways. For example, the service provider 136 may use the consumer's phone number 124 to identify the name or particular identity of the consumer 122. The biometric database 140 may link the consumer's particular identity to the stored copies of the biometric trait 132, and thus, the service provider 136 uses the consumer's particular identity (based on the phone number 124) to search the database 140 for the corresponding biometric trait 132 of the consumer 122. This may be a useful approach when the biometric database 140 is maintained by a central organization like a governmental organization. Alternatively, the financial institutions associated with each financial account 128 may maintain their own biometric databases 140. In this case, the service provider 136 may transmit the biometric trait 132 received from the consumer 122 to the financial institution associated with the selected financial account 130. The financial institution associated with the selected financial account 130 then compares the entered biometric trait 132 with a corresponding stored copy of the biometric trait 132 to determine if they match. Where the biometric traits 132 are stored in a central database 140 like a governmental database, the service provider 136 may transmit the entered biometric trait 132 to the central organization for comparison or the service provider 136 may have access to the database 140 to perform the comparison itself. Preferably, the biometric database 140 and the phone database 138 are maintained by different organizations. For example, where a governmental organization maintains the biometric database 140, it would be unlikely or undesirable for the governmental organization to also maintain the phone database 138 with links between consumer's phone numbers 124 and their financial accounts 128. On the other hand, where the financial institutions associated with each financial account 128 maintain their own biometric databases 140, a separate phone database 138 would be necessary because it is likely that a consumer 122 will have financial accounts 128 with multiple financial institutions and it is desirable for the system to list all financial accounts 128 belonging to the consumer 122 regardless of the financial institutions associated with the accounts 128.

It is understood that the described authorization system is intended to operate autonomously on programmed computer systems utilizing computer algorithms such that the system may be implemented by one or more computer processors (e.g., in a server system) executing computer-executable instructions stored on a non-transitory computer-readable storage medium. Thus, for example, in the case of the service provider 36 and other steps described herein, it is unnecessary for human beings to make the required data transmissions, determinations, etc. This autonomous design makes the improved payment system scalable to a level that would be impractical if human beings were to attempt to perform the steps required by the system. While it is understood that various human beings may provide inputs to the system and may adjust parameters that control how the system operates, the improved financial transaction authorization system is intended to have the capability of processing many thousands of transactions in short periods of time (e.g., seconds or less) that would be impossible to accomplish with human intervention in each transaction.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A method of authorizing financial transactions, comprising:
receiving a first input at a user interface by a consumer, the first input being a series of numbers representing a consumer's phone number;
displaying a plurality of financial accounts on the user interface to the consumer, each of the plurality of financial accounts being linked to the consumer's phone number;
selecting one of the plurality of financial accounts by the consumer to conduct a financial transaction;
receiving a second input at the user interface by the consumer, the second input being a biometric trait of the consumer;
comparing the biometric trait of the consumer with a corresponding stored copy of the biometric trait of the consumer; and
authorizing the financial transaction using the selected financial account if the biometric trait entered by the consumer matches the corresponding stored copy of the biometric trait of the consumer, and rejecting the financial transaction using the selected financial account if the biometric trait entered by the consumer does not match the corresponding stored copy of the biometric trait of the consumer.

2. The system of authorizing financial transactions according to claim 1, further comprising receiving a third input at the user interface by the consumer, the third input being a PIN or password, wherein the plurality of financial accounts is only displayed if the PIN or password matches a corresponding stored copy of the PIN or password.

3. The system of authorizing financial transactions according to claim 1, wherein the biometric trait is a fingerprint.

4. The system of authorizing financial transactions according to claim 1, wherein the corresponding stored copy of the biometric trait is stored in a biometric database with many stored copies of the biometric trait, each stored copy of the biometric trait being associated with a different consumer.

5. The system of authorizing financial transactions according to claim 4, wherein the biometric database is maintained by a financial institution associated with the selected one of the plurality of financial accounts.

6. The system of authorizing financial transactions according to claim 4, wherein the biometric database is maintained by a governmental organization.

7. The system of authorizing financial transactions according to claim 1, wherein the user interface is a point of sale (POS) device physically located at a merchant site, the POS comprising a display screen, a number pad and a biometric reader.

8. The system of authorizing financial transactions according to claim 1, wherein the user interface is a computer device located remote from a merchant site, the computer device comprising a display screen, a number pad and a biometric reader.

9. The system of authorizing financial transactions according to claim 1, wherein the financial transaction comprises a purchase from a merchant.

10. The system of authorizing financial transactions according to claim 9, wherein the purchase is authorized without the consumer presenting a physical or digital financial card to the merchant.

11. The system of authorizing financial transactions according to claim 1, further comprising a phone database, the phone database linking many consumers' phone numbers with financial accounts associated with each consumer.

12. The system of authorizing financial transactions according to claim 11, wherein the phone database is maintained by a financial services organization different from financial institutions associated with the plurality of financial accounts.

13. The system of authorizing financial transactions according to claim 11, wherein the corresponding stored copy of the biometric trait is stored in a biometric database with many stored copies of the biometric trait, each stored copy of the biometric trait being associated with a different consumer.

14. The system of authorizing financial transactions according to claim 13, wherein the biometric database and the phone database are maintained by different organizations.

15. The system of authorizing financial transactions according to claim 14, wherein the biometric database is maintained by a financial institution associated with the selected one of the plurality of financial accounts.

16. The system of authorizing financial transactions according to claim 14, wherein the biometric database is maintained by a governmental organization.

17. The system of authorizing financial transactions according to claim 11, further comprising receiving a third input at the user interface by the consumer, the third input being a PIN or password, wherein the plurality of financial accounts is only displayed if the PIN or password matches a corresponding stored copy of the PIN or password.

18. The system of authorizing financial transactions according to claim 17, wherein the PIN or password is linked to the consumer's phone number, the PIN or password being stored in the phone database.

19. The system of authorizing financial transactions according to claim 18, wherein the biometric trait is a fingerprint.

20. The system of authorizing financial transactions according to claim 19, wherein the user interface is a point of sale (POS) device physically located at a merchant site, the POS comprising a display screen, a number pad and a biometric reader.
